(19) United States
(12) Patent Application Publication
(10) Pub. No.: US 2023/0075535 A1
(43) Pub. Date: Mar. 9, 2023

(54) AUTOMATED LABORATORY APPARATUS AND A METHOD OF PROCESSING A SAMPLE

(71) Applicant: Hombrechtikon Systems Engineering AG, Hombrechtikon (CH)

(72) Inventors: Hans-jürgen TIEDTKE, Bonn (DE); Harald QUINTEL, Steckborn (CH); Konstantin LUTZE, Uerikon (CH)

(21) Appl. No.: 17/796,254

(22) PCT Filed: Mar. 3, 2020
(86) PCT No.: PCT/EP2020/055532

§ 371 Date: Jul. 28, 2022

(51) Int. Cl. G01N 35/00

(52) U.S. Cl. CPC G01N 35/0099; G01N 2035/1048

(57) ABSTRACT

An automated laboratory apparatus for processing a sample includes a treatment chamber for receiving the sample, a movement device arranged movably in at least one first spatial direction of the treatment chamber, an analysis unit arranged in the treatment chamber for analyzing the sample, which analysis unit can be received by the movement device and can be moved to the sample by the movement device, and an electronic control device which is signal-connected to the movement device and the analysis unit.

### CROSS-REFERENCE TO RELATED APPLICATION

This application is a U.S. National Stage application of International Application No. PCT/EP2020/055532, filed Mar. 3, 2020, the contents of which is hereby incorporated by reference.

### BACKGROUND

### Field of the Invention

The disclosure relates to an automated laboratory apparatus for processing a sample and a method of processing a sample.

### Background Information

When processing a plurality of samples, a plurality of processing steps must be performed. For this purpose, automated laboratory apparatuses are usually used since a precise pipetting of reagents into and out of containers such as microwell plates must be ensured.

Here, conventional automated laboratory apparatuses usually comprise a treatment chamber in which the samples are introduced in microwell plates (or other containers); a pipetting device for performing the processing steps; a movement device for moving the pipetting device in the treatment chamber and an electronic control device which controls and instructs the pipetting device and other parts of the automated laboratory apparatus for performing the processing steps.

Thus, an automated sample preparation process with increased efficiency and improved throughput is ensured by using the automated laboratory apparatuses.

Conventional automated laboratory apparatuses often also have integrated optical detection devices for analyzing the samples. The detection devices are arranged stationary in the automated laboratory apparatus and samples are transported to the detection device by means of a gripper and analyzed there, whereby, however, the flexibility of the known devices is limited.

Particularly preferred, automated laboratory apparatuses are used in biochemistry for processing biological samples, such as biomolecules (for example DNA; RNA, . . . ).

In particular for biomolecules, luminescence spectroscopy is an important analytical method in which the emission light, which is generated based on a photon absorption of the biomolecules, is evaluated.

For this purpose, fluorescent chemical groups can be attached to large biomolecules by a fluorescent labeling, which then serve as markers for this biomolecule.

Fluorescence is understood to be the brief, spontaneous emission of light that occurs when an electronically excited system transitions back to a lower energy state. Thus, fluorescence is a form of luminescence in which the excitation occurs by absorption of photons (photoluminescence). Formally, fluorescence thus represents the reverse of the adsorption of light, in which a deactivation of excited electron states takes place by re-emission of the excitation energy as radiation.

In many processes, the concentration of the fluid samples (i.e., of the relevant molecules in solution) in particular plays a role for further processing, which can be easily determined, in particular, by fluorescence spectroscopy.

### SUMMARY

It has been determined that the main disadvantages of the conventional devices lie in the lack of flexibility of the systems.

It is therefore an object of the disclosure to provide an automated laboratory apparatus and a method of processing a sample, which avoid the adverse effects known from the conventional devices, in particular to provide a highly flexible automated laboratory apparatus with independent components.

The object is met by an automated laboratory apparatus for processing a sample and a method of processing a sample with the features described herein.

The disclosure further relates to particularly advantageous embodiments of the invention.

According to an embodiment of the invention, an automated laboratory apparatus for processing a sample is proposed, comprising a treatment chamber for receiving the sample, a movement device arranged movably in at least one first spatial direction of the treatment chamber, an analysis unit arranged in the treatment chamber for analyzing the sample, which analysis unit can be received by the movement device and can be moved to the sample by means of the movement device and an electronic control device which is signal-connected to the movement device and the analysis unit.

In a particularly preferred embodiment, a sample processing device for performing at least one processing step on the sample is additionally arranged in the treatment chamber. The sample processing device is included in the movement device, in particular arranged on the movement device. In this way, the sample processing device can be moved by means of the movement device in the first spatial direction through the treatment chamber. The sample processing device particularly comprises a receiving element for receiving the analysis unit, so that the analysis unit can be moved to the sample by means of the movement device in the operating state. The sample processing device is also signal-connected to the control device.

The analysis unit can be designed as a wireless analysis unit with an energy storage device, and the automated laboratory apparatus can comprise a charging station arranged in the treatment chamber for storing the analysis unit and for charging the energy storage device. Due to the energy storage device, the analysis unit can then be operated without a power cable (permanent power connection).

According to an embodiment of the invention, a method of processing the sample in the automated laboratory apparatus is further proposed. The sample is introduced into the treatment chamber. The analysis unit is received by the movement device and is moved by the movement device through the treatment chamber to the sample. Then, the sample is analyzed by the analysis unit.

Preferably, the analysis unit can be designed as a (in particular also as a wireless) detection device comprising a radiation source for irradiating the sample with a primary radiation and a detector for receiving a secondary radiation originating from the sample.

If the analysis unit is designed as the wireless detection device, it is received from the charging station by means of the receiving element of the sample processing device and moved by means of the movement device (at least) in the first spatial direction through the treatment chamber from the charging station to the sample. Subsequently, the sample is analyzed by the detection device.

In practice, a container is usually arranged in the treatment chamber to receive the samples. In particular, the container can be a microwell plate, wherein the microwell plate comprises a plurality of wells for receiving the samples (or different samples).

Within the framework of this disclosure, the term “sample” can be understood to mean, in particular, a sample comprising a fluid containing substances such as biomolecules (inter alia DNA, RNA, nucleic acids, proteins, cells and cell components, monomers) or other chemical substances. Within the framework of the disclosure, a liquid can be, for example, a suitable solvent.

In an embodiment of the invention, the detection device can comprise a radiation source for irradiating the sample with a primary radiation and a detector for receiving a secondary radiation originating from the sample. Thus, the radiation source generates an electromagnetic radiation (the primary radiation). The secondary radiation is in particular an electromagnetic secondary radiation emitted by the sample, which secondary radiation is induced by an interaction of the primary radiation with the sample.

Here. UV/V is radiation, in particular in the wavelength range of 190-800 nm, especially 365-720 nm, is particularly preferably used as primary radiation. Here, a diode, in particular a silicon photodiode or a vacuum photodiode, is particularly suitable as a detector. A laser, a deuterium lamp, a tungsten lamp, a halogen lamp, or a LED (light emitting diode) can be used as radiation sources.

In practice, the detection device can also comprise a plurality of detectors and/or radiation sources. The radiation sources can emit different wavelengths or wavelength ranges as primary radiation. Here, the use of two radiation sources is particularly preferred, which are designed as a first radiation source (preferably first LED) with a first wavelength (e.g., 350-400 nm) and a second radiation source (preferably second LED) with a second wavelength (e.g., 700-750 nm). If a plurality of radiation sources is present, the analysis can be performed confocally. The beam paths of the primary radiation from the different radiation sources are thus directed to a common focal point in the fluid sample.

Thus, the detection device can be a photometer, in particular a spectrometer, especially a fluorometer/fluorescence photometer. The fluorometer measures the parameters of fluorescence of the fluid sample: intensity and wavelength distribution of the emission spectrum (of the secondary radiation) after excitation by the primary radiation.

Within the framework of the disclosure, fluorescence spectroscopy is used particularly preferably as the measurement principle, whereby the radiation source generates primary radiation in the UV/Vis range and the fluorescence emission of the fluid sample is captured by means of the detector.

In principle, an adsorption of the sample can also be measured by the radiation source not being part of the detection device and being arranged on the container. Since the setup of the device is complicated by such an arrangement, the analysis of the emission is preferred, in particular the fluorescence emission, so that the radiation source and the detector can be integrated into the detection device.

As an alternative, the analysis unit can be designed as an infrared photometer for optical temperature measurement and/or a pH meter and/or a camera and/or an ultrasonic sensor and/or a laser and/or a laser interferometer and/or a UVC unit (preferably LED with 260-280 nm) for local decontamination of the treatment chamber. The object of the disclosure is described in more detail on the basis of the preferred embodiment of the optical analysis but is not limited thereto. For example, the camera can be used to scan barcodes in the treatment chamber or to inventory a work deck in the treatment chamber.

In a particularly preferred embodiment, the sample processing device can be designed as a pipetting device for receiving and dispensing a fluid and the receiving element can be designed to receive a pipette tip.

In particular, the receiving element can comprise a head for receiving the pipette tip, wherein the detection device comprises a port corresponding to a shape of the head, such that the detection device can be received in the operating state by the sample processing device by inserting the head into the corresponding port.

The head can be designed as a pointed cone for receiving a pipette tip, wherein the shape of the port corresponds to the shape of the pointed cone (i.e., in particular, simply a round opening). Of course, the head can also have another suitable shape, such as the shape of a cuboid, for example. Since pipette tips usually have a round opening, however, the head is preferably designed as the pointed cone, which tapers in the direction of the pipette tip (or detection device) to be received, so that the pipette tip (or detection device) can be received more easily.

In a particularly preferred embodiment, the receiving element can comprise a core, to which core the pointed cone (or, in the case of an unspecified shape, the head) is attached, wherein a sleeve is arranged movably along a cone axis of the pointed cone, around the core, in such a way that the detection device can be ejected in the operating state by a movement of the sleeve along the cone axis in the direction of the pointed cone. This can be ejected by a pressure which is exerted by the sleeve on the detection device (or a pipette tip) during this movement.

As an alternative, a robot arm with a gripper can be arranged on the movement device, by which, inter alia, the analysis unit can be received and transported.

Of course, the receiving element can also comprise another ejection device which, in the operating state, can act on the detection device received in the receiving element in such a way that the detection device can be ejected into the charging station.

In principle, the energy storage device can be a capacitor and/or an accumulator. It is ensured by the energy storage device that the detection device can be used “wirelessly”, i.e., it can be operated at least temporarily without an external power connection. In this way, the detection device can be flexibly moved inside the automated laboratory apparatus without a power cable to analyze the fluid samples at different points in the treatment chamber or at different process steps and can then be brought into the charging station to be stored there and to charge the energy storage device for further analyses.

In principle, the automated laboratory apparatus can also comprise several (wireless) detection devices according to embodiments of the invention, so that detection devices with, for example, different radiation sources can be used as required.

The fact that the electronic control device is signal-connected to the sample processing device, the movement device and the detection device, means that in the operating state the control device sends control signals for performing the processing steps to the sample processing device, the movement device and the detection device. In addition, signals can also be received from the sample processing device, the movement device and the detection device.

In the case of the detection device and/or the sample processing device and/or the movement device, the signal connection can be made via a cable connection or wirelessly. In the case of the detection device, however, the signal connection is preferably wireless. In the case of the wireless signal connection, the data/signal transmission takes place via free space (air or vacuum) as the transmission device. The transmission can be done by directional or non-directional electromagnetic waves, wherein a range of the frequency band to be used can vary from a few hertz (low frequency) to several hundred terahertz (visible light) depending on the application and the technology used. Preferably, Bluetooth or WLAN is used for this. Thus, not only the detection device can be controlled by the control device, but after the fluid samples have been analyzed, the measured data can be transmitted to the control device for evaluation, for example to determine a concentration of the fluid sample before further processing.

Of course, it is preferred that the movement device can be moved in a second spatial direction of the treatment chamber, orthogonal to the first spatial direction, as well as in a third spatial direction of the treatment chamber, orthogonal to the first spatial direction and the second spatial direction so that the detection device can be moved flexibly in the entire automated laboratory apparatus. The movement device is preferably driven by an electric motor such as a servo motor and can move, for example, as a freely movable arm or via rails.

In the method according to embodiments of the invention (or in the operating state), the detection device can thus be moved through the treatment chamber by means of the movement device in all spatial directions (first, second and third spatial directions within the framework of the application). In particular, after analyzing the sample, there can be movement of the detection device from the sample to the charging station, there can be movement of the detection device from a first sample to a second sample, and a movement of the detection device from the charging station to the sample. If the sample processing device is a pipetting device, not only the movement of the detection device is performed by means of the pipetting device and the movement device, but also different fluids (such as the fluid sample) can be transported through the treatment chamber, for which in particular pipette tips are applied to the pipetting device. In this way, fluids can be pipetted in different processing steps. However, within the framework of this application, the analysis by means of the detection device is also a processing step.

Here, the advantage lies in particular in the fact that known automated laboratory apparatuses can be easily retrofitted to an automated laboratory apparatus according to embodiments of the invention, since the already existing pipetting devices can be used as a sample processing device with a corresponding movement device. Thus, existing systems can be retrofitted by integrating a detection device with charging station according to embodiments of the invention.

Above, many different measures for the design of the automated laboratory apparatus were described. In an embodiment preferred in practice, these measures can be combined as follows.

The fluid sample comprises biomolecules and the microwell plate is arranged in the treatment chamber to receive the fluid samples. The detection device comprises two radiation sources for irradiating the fluid sample with the primary radiation and the detector (preferably silicon photodiode) for receiving a secondary radiation originating from the fluid sample. The primary radiation is generated as UV/V is radiation by the two radiation sources (preferably LEDs) in two different wavelengths (such as 360 nm and 720 nm). The detection device is designed as a fluorometer. Thus, the secondary radiation (detectable by the detector) corresponds to the fluorescence emission of the fluid sample. The sample processing device is designed as a pipetting device for receiving and dispensing a fluid (as well as the fluid sample), and the receiving element comprises the pointed cone, wherein the detection device comprises the port corresponding to the shape of the pointed cone. The movement device can be moved in all spatial directions of the treatment chamber.

### BRIEF DESCRIPTION OF THE DRAWINGS

Embodiments of the invention will be explained on more detail hereinafter with reference to the drawings.

FIG. 1 illustrates a schematic representation of an automated laboratory apparatus according to an embodiment of the invention;

FIG. 2 illustrates a schematic representation of a further embodiment of an automated laboratory apparatus according to the invention;

FIGS. 3A-3C illustrate a schematic representation of the use of the detection device according to an embodiment of the invention;

FIGS. 4A and 413 illustrate a schematic representation of the irradiation of a fluid sample:

FIGS. 5A and 5B illustrate a schematic representation of a receiving element according to an embodiment of the invention; and

FIG. 6 illustrates a further schematic representation of a pointed cone according to FIG. 5.

### DETAILED DESCRIPTION

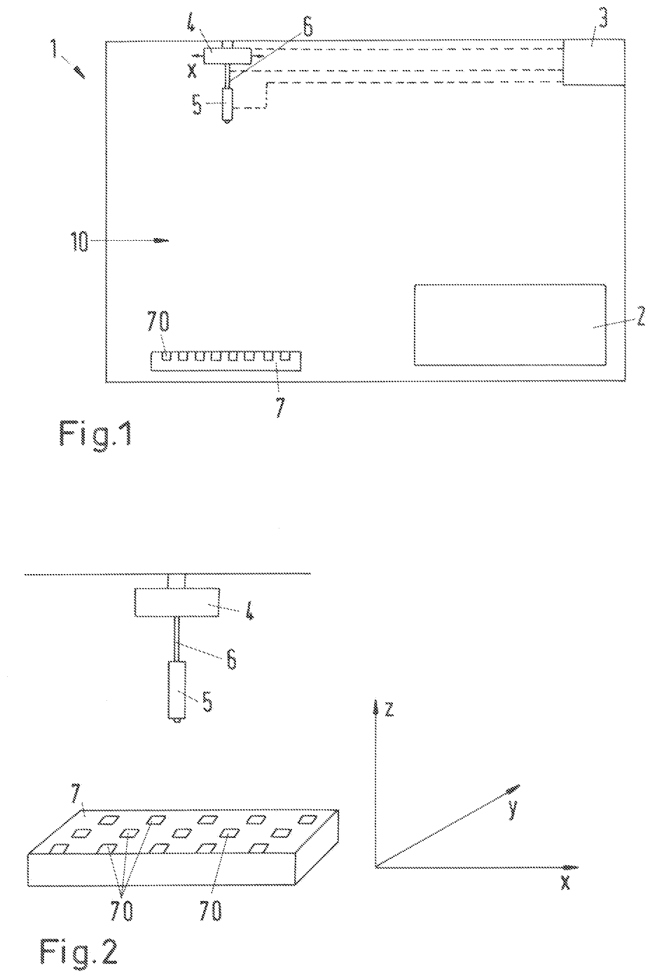

FIG. 1 shows a schematic representation of an automated laboratory apparatus 1 according to an embodiment of the invention.

The automated laboratory apparatus 1 for processing a fluid sample comprises a treatment chamber 10 for receiving the fluid sample and a sample processing device 6 arranged in the treatment chamber 10 for performing at least one processing step (at least analysis of the fluid sample) on the fluid sample.

In addition, a movement device 4 is arranged in the treatment chamber 10. The movement device 4 can be moved at least in a first spatial direction x of the treatment chamber 10. The movement device 4 is connected to the sample processing device 6 in such a way (i.e., the sample processing device 6 is included in the movement device 4 in such a way) that the sample processing device 6 can be moved through the treatment chamber 10 in the first spatial direction x by means of the movement device 4.

A detection device 5 with an integrated energy storage device for analyzing the fluid sample is reversibly attached to the sample processing device 6. Here, the detection device 5 is a wireless detection device 5.

In addition, a charging station 2 is arranged in the treatment chamber for storing the detection device 5 and for charging the energy storage device. Thus, after analyzing a fluid sample, the detection device 5 can be removed from the sample processing device 6 and inserted into the charging station 2.

The energy storage device is preferably a capacitor and/or an accumulator, which can be charged in the charging station 2. Due to the energy storage device, the wireless use of the detection device 5 is ensured, since it can be operated at least temporarily without an external power connection.

This has the advantage that the detection device 5 can be moved flexibly in the treatment chamber 10 of the automated laboratory apparatus without an interfering connecting cable.

In addition, the automated laboratory apparatus 1 comprises an electronic control device (electronic controller) 3 which is signal-connected to the sample processing device (processor) 6, the movement device (mover) 4 and the detection device (detector) or analysis unit (analyzer) 5. Here, the signal connection is indicated by the dashed lines.

In the operating state, the control device 3 can thus send control signals to the sample processing device 6, the movement device 4, and the detection device 5 for performing various processing steps. Of course, the control device 3 can also receive signals from the sample processing device 6, the movement device 4 and the detection device 5.

In the case of the sample processing device 6 and/or the movement device 4, the signal connection is made via a cable connection to the control unit 3. In the case of the detection device 5, the signal connection is wireless. Thus, the data/signal transmission takes place via a free space (air or vacuum) as the transmission device. Electromagnetic radiation such as Bluetooth or WLAN is used for transmission.

The detection device 5 is controlled by the control device 3 so that analyse, are performed on a predeterminable well 70 of a container 7 arranged in the treatment chamber 10. After analyzing the fluid samples, the measured data is transmitted from the detection device 5 to the control device 3 for evaluation.

FIG. 2 shows a schematic representation of a further embodiment of an automated laboratory apparatus 1 according to the invention with an equivalent structure as the automated laboratory apparatus 1 according to FIG. 1.

However, the movement device 4 can additionally be moved in a second spatial direction y of the treatment chamber, orthogonal to the first spatial direction x, as well as in a third spatial direction z of the treatment chamber, orthogonal to the first spatial direction x and the second spatial direction y, so that the detection device 5 can be moved flexibly to the different wells 70 of the container 7, which is designed as a microwell plate.

In the operating state, the detection device 5 can thus be moved by means of the movement device 4 in all spatial directions x, y, z through the treatment chamber 10. In particular, after analyzing the fluid sample, a movement of the detection device 5 from the fluid sample to the charging station can take place. In addition, a movement of the detection device 5 from a first fluid sample to a second fluid sample and a movement of the detection device 5 from the charging station to the fluid sample can take place.

If the sample processing device 6 is a pipetting device 6, not only the movement of the detection device 5 takes place by the pipetting device 6 and the movement device 4, but various fluids (such as on the fluid sample) can also be transported through the treatment chamber 10.

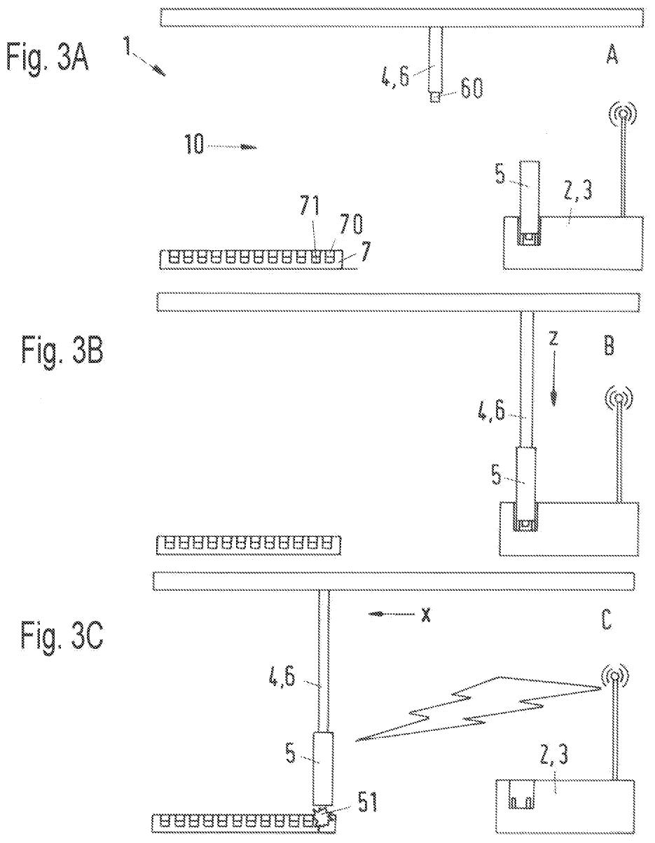

FIGS. 3A-3C show a schematic representation of the use of the detection device 5 according to embodiments of the invention in the automated laboratory apparatus 1 according to embodiments of the invention. The automated laboratory apparatus 1 according to FIGS. 3A-3C has an equivalent structure as the automated laboratory apparatus 1 according to FIG. 1, but the movement device 4 can be moved in all spatial directions. In addition, the sample processing device 6 is integrated into the movement device 4, and the charging station 2 is integrated into the control unit 3.

The sample processing device 6 comprises a receiving element 60 for receiving the detection device 5.

In FIG. 3A, the detection device 5 is located in the charging station 2 and the energy storage device of the detection device 5 is charged.

In FIG. 3B, the sample processing device 6 with its receiving element 60 moves along the third spatial direction z in the direction of the detection device 5, so that the detection device 5 is received from the sample processing device 6 by the receiving element 60.

In FIG. 3C, the detection device 5 is transported by the movement device 4 in the first spatial direction x from the charging station 2 to the fluid sample 71, which is located in the well 70 of the container 7 and the fluid sample 71 is analyzed by means of the detection device 5. The fluid sample 71 is particularly advantageously analyzed/irradiated via an opening of the well 70 without the primary radiation 51 having to be guided through a material of the container 7 in order to reach from the radiation source to the fluid sample 71.

For this purpose, the detection device 5 comprises an integrated radiation source for irradiating the fluid sample with a primary radiation 51 and an integrated detector for receiving a secondary radiation originating from the fluid sample.

The radiation source thus generates the primary radiation as an electromagnetic radiation in the UV/Vis range, in particular in the wavelength range of 190-800 nm, especially 365-720 nm. The secondary radiation is in particular an electromagnetic secondary radiation emitted by the fluid sample, which secondary radiation is induced by an interaction of the primary radiation with the fluid sample.

The detector is preferably designed as a silicon photodiode and the radiation sources as a LED (light emitting diode).

The detection device 5 is designed as a fluorometer for measuring the fluorescence intensity. The fluorometer 5 measures the intensity and wavelength distribution of the emission spectrum (secondary radiation) of the fluid sample 71 after excitation by the primary radiation 51.

Preferably, the fluid sample 71 comprises biomolecules and a solvent. The fluorescence intensity can be used to determine the concentration of the biomolecules. Here, a fluorescent marker for the biomolecules could be used.

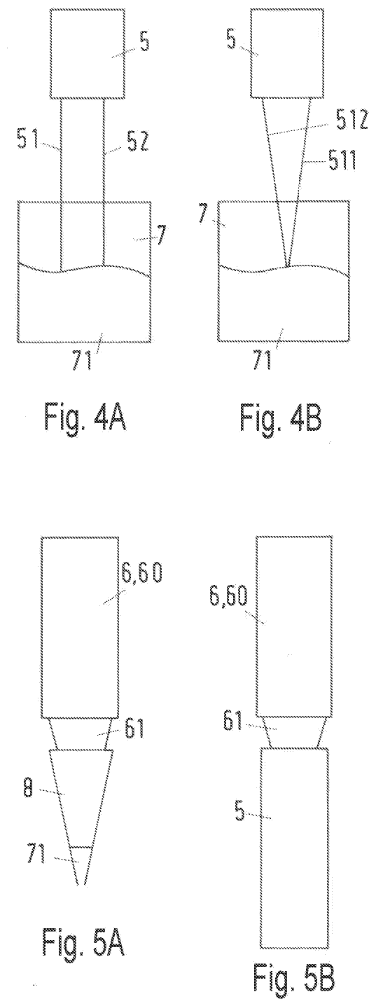

FIGS. 4A and 413 show a schematic representation of the irradiation of the fluid sample 71. For this purpose, a fluorometer 5 is used as detection device 5, as described for FIGS. 3A-3C.

The primary radiation 51 is irradiated from above directly onto the fluid sample 71 through an opening of the container 7.

The secondary radiation 52 is received by the detector integrated in the detection device. The secondary radiation 52 is the electromagnetic secondary radiation 52 emitted from the fluid sample 71, which secondary radiation 52 is induced by an interaction of the primary radiation 51 with the fluid sample. The secondary radiation 52 corresponds to the fluorescence emission of the fluid sample 71.

The detection device 5 can comprise two radiation sources for irradiating the fluid sample with primary radiation in two different wavelengths in the UV/Vis range. By using two radiation sources, a first primary radiation 511 with a first wavelength (e.g., 350-400 nm) is generated by a first radiation source and a second primary radiation 512 with a second wavelength (e.g., 700-750 nm) is generated by a second radiation source (preferably second LED). The analysis of the fluid sample is confocal, the beam paths of the primary radiation 511, 512 from the various radiation sources are directed to a common focal point in the fluid sample 71.

FIGS. 5A and 5B show a schematic representation of a receiving element 60 according to an embodiment of the invention.

The sample processing device 6 is configured as a pipetting device 6 for receiving and dispensing a fluid, and the receiving member 60 comprises a head 61 for receiving a pipette tip 8, wherein the detection device 5 comprises a port corresponding to a shape of the head 61, so that the detection device 5 can be received by the sample processing device 6 in the operating state by inserting the head 61 into the corresponding port.

The head 61 is designed as a pointed cone 61 for receiving a pipette tip 8, wherein the shape of the port corresponds to that of the pointed cone 61.

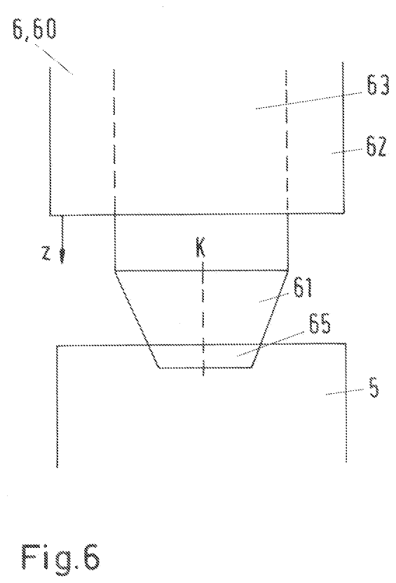

FIG. 6 shows a further schematic representation of the pointed cone according to FIGS. 5A and 5B.

The pointed cone 61 is designed in such a way that it tapers in the direction of the port 65 so that the detection device 5 can be more easily received.

The receiving element 60 comprises a core 63, to which core 63 the pointed cone 61 is attached, wherein a sleeve 62 is arranged movably along a cone axis of the pointed cone around the core in such a way that the detection device can be ejected in the operating state by a movement of the sleeve along the cone axis K in the direction of the pointed cone 61 (in the spatial direction z). Due to a pressure which is exerted by the sleeve 63 on the detection device 5 during this movement, the latter can be ejected. Thus, the detection device 5 can be inserted again to the charging station.

1. An automated laboratory apparatus for processing a sample comprising:
a treatment chamber configured to receive the sample;
a movement device movably arranged in a first spatial direction of the treatment chamber;
an analysis unit arranged in the treatment chamber and configured to analyze the sample, the analysis unit configured to be received by the movement device and moved to the sample by the movement device; and
an electronic controller signal-connected to the movement device and the analysis unit.

2. The automated laboratory apparatus according to claim 1, wherein the movement device comprises a sample processing device configured to perform a processing step on the sample, and the sample processing device comprises a receiving element configured to receive the analysis unit, so that the analysis unit is capable of being moved to the sample by the movement device in an operating state.

3. The automated laboratory apparatus according to claim 1, wherein the analysis unit is a wireless analysis unit with an energy storage device, and the automated laboratory apparatus comprises a charging station arranged in the treatment chamber configured to store the analysis unit and charge the energy storage device.

4. The automated laboratory apparatus according to claim 1, wherein the analysis unit is a detection device comprising a radiation source configured to irradiate the sample with a primary radiation and a detector configured to receive a secondary radiation originating from the sample.

5. The automated laboratory apparatus according to claim 4, wherein the detector is a diode.

6. The automated laboratory apparatus according to claim 4, wherein the radiation source is a deuterium lamp, a tungsten lamp, a halogen lamp, or a LED.

7. The automated laboratory apparatus according to claim 4, wherein the detection device comprises a plurality of detectors or radiation sources.

8. The automated laboratory apparatus according to claim 1, wherein the analysis unit is designed as an infrared photometer configured to measure optical temperature or a pH meter or a camera or an ultrasonic sensor or a laser or a laser interferometer and/or a UVC unit for local decontamination of the treatment chamber.

9. The automated laboratory apparatus according to claim 3, wherein the energy storage device is a capacitor or a battery or an accumulator.

10. The automated laboratory apparatus according to claim 4, wherein the detection device is a photometer.

11. The automated laboratory apparatus according to claim 1, wherein the movement device is configured to be moved in a second spatial direction of the treatment chamber, the second spatial direction orthogonal to the first spatial direction, and in a third spatial direction of the treatment chamber, the third spatial direction orthogonal to the first spatial direction and the second spatial direction.

12. The automated laboratory apparatus according to claim 2, wherein the sample processing device is a pipetting device configured to receive and dispense a fluid and the receiving element is configured to receive a pipette tip.

13. A method of processing a sample with an automated laboratory apparatus, comprising:
providing the automated laboratory apparatus according to claim 1;
introducing the sample into the treatment chamber;
receiving the analysis unit by the movement device;
moving the analysis unit by the movement device through the treatment chamber to the sample; and
analyzing the sample by the analysis unit.

14. The method according to claim 13, wherein the analysis unit is a wireless detection device, the movement device comprises a sample processing device, and the automated laboratory apparatus comprises a charging station and the wireless detection device is received by a receiving element of the sample processing device and is transported by the movement device through the treatment chamber from the charging station to the sample.

15. The method according to claim 14, comprising moving the detection device by the movement device through the treatment chamber from the sample to the charging station after analyzing the sample.

16. The method according to claim 14, further comprising irradiating the sample with a primary radiation by a radiation source of the detection device and receiving a secondary radiation originating from the sample by a detector of the detection device.

17. The method according to claim 16, further comprising determining a concentration of the sample based on the secondary radiation.

18. The automated laboratory apparatus according to claim 4, wherein the detector is a silicon photodiode or a vacuum photodiode.

19. The automated laboratory apparatus according to claim 4, wherein the detection device is a spectrometer.

20. The automated laboratory apparatus according to claim 4, wherein the detection device is a fluorometer.
